(19) United States
(12) Patent Application Publication
(10) Pub. No.: US 2020/0269582 A1
(43) Pub. Date: Aug. 27, 2020

(54) INK JET RECORDING DEVICE

(71) Applicant: KONICA MINOLTA, INC., Chiyoda-ku, Tokyo (JP)

(72) Inventors: Hiroaki ARAKAWA, Toyohashi-shi, Aichi-ken (JP); Fujio MIYAMOTO, Hino-shi, Tokyo (JP)

(73) Assignee: KONICA MINOLTA, INC., Chiyoda-ku, Tokyo (JP)

(21) Appl. No.: 16/651,741

(22) PCT Filed: Oct. 17, 2017
(86) PCT No.: PCT/JP2017/037556

§ 371 Date: Mar. 27, 2020

(51) Int. Cl. B41J 2/155; B41J 11/46; B41J 29/38; B41M 1/26; B41M 3/18

(52) U.S. Cl. CPC B41J 2/155; B41J 11/46; B41M 3/18; B41M 1/26; B41J 29/38

(57) ABSTRACT

Disclosed is an ink jet recording device including: a conveyer that conveys a long sheet-shaped base material in a flatly extended state; a single-pass ink jet printer that ejects ink from multiple nozzles that are arranged in a width direction of the base material, so as to performs printing on the base material conveyed by the conveyer; and a controller that controls the conveyer to change a conveyance speed of the base material relative to the printer between a first conveyance speed and a second conveyance speed that are different from each other, wherein the controller controls the printer to form cut position information on the base material before start of changing the conveyance speed between the first conveyance speed and the second conveyance speed and after completion of changing the conveyance speed between the first conveyance speed and the second conveyance speed.

### TECHNICAL FIELD

The present invention relates to an ink jet recording device.

### BACKGROUND ART

Ink jet printing methods enable printing on a wide variety of base materials. In view of this, there are attempts to incorporate an ink jet printer as one of multiple manufacturing processes executed by a manufacturing device.

One of such manufacturing devices is a wall paper manufacturing device. In the field of manufacturing wall papers, multiple processes may be performed prior to subsequent to a process of printing on a base material. Wall paper manufacturing devices that continuously perform these multiple processes and a printing process by an ink jet printer, have been developed (for example, Patent Documents 1 to 3).

### CITATION LIST

### Patent Literature

Patent Document 1: JP 4620903B

Patent Document 2: JP 2001-232910A

Patent Document 3: JP 2007-5343252A

### SUMMARY Of INVENTION

### Technical Problem

However, the ink jet printer that is incorporated in a conventional wall paper manufacturing device employs a shuttle ink jet printing method, and this makes it difficult to sufficiently increase the printing speed.

In some cases, a wall paper manufacturing device is mounted with any one of units for performing a process other than printing, such as a unit for coating a base material or a unit for embossing a base material, and the processing speed must be matched with that of the ink jet printer. This makes it difficult to increase the processing speed and results in low productivity.

On the other hand, single-pass ink jet printers can perform printing at higher speed, and therefore, this type of printers are expected to solve the above problems.

However, the ejection time interval of single-pass ink jet printers is limited for correctly ejecting ink due to the structure of a head, density variations can occur due to the fixed amount of liquid per ejection, and an aspect ratio can be changed. These primary reasons make it difficult to freely adjust a conveyance speed of a base material in printing. Thus, a higher conveyance speed in the printing process cannot be matched with a lower conveyance speed in other process, whereby it is difficult to succesively perform these processes.

An object of the invention is to provide an ink jet recording device that is configured to perform a printing process and other process successively at high speed.

### Solution to Problem

The invention recited in claim 1 is an ink jet recording device comprising:

a conveyer that conveys a long sheet-shaped base material in a flatly extended state;

a single-pass ink jet printer that ejects ink from multiple nozzles that are arranged in a width direction of the base material, so as to performs printing on the base material conveyed by the conveyer; and

a controller that controls the conveyer to change a conveyance speed of the base material relative to the printer between a first conveyance speed and a second conveyance speed that are different from each other,

wherein the controller controls the printer to form cut position information on the base material before start of changing the conveyance speed between the first conveyance speed and the second conveyance speed and after completion of changing the conveyance speed between the first conveyance speed and the second conveyance speed.

The invention recited in claim 2 is the ink jet recording device according to claim 1,

wherein the printer forms images on the base material, the images being repeated every predetermined distance in a conveyance direction of the conveyer, and

wherein the controller controls the conveyer to change the conveyance speed between the first conveyance speed and the second conveyance speed after a repeated image having the predetermined distance is formed but before a next repeated image having the predetermined distance is formed.

The invention recited in claim 3 is the ink jet recording device according to claim 1 or 2,

wherein the cut position information is represented by a line, a mark, a boundary between images, or another visually recognizable form.

The invention recited in claim 4 is the ink jet recording device according to any one of claims 1 to 3,

wherein the first conveyance speed is higher than the second conveyance speed.

The invention recited in claim 5 is the ink jet recording device according to claim 4, further comprising:

a pre-process conveyer that is disposed at a conveyance upstream of the conveyer and conveys the base material in the flatly extended state; and

a base material process unit that performs a process other than printing on the base material conveyed by the pre-process conveyer,

wherein a conveyance speed of the pre-process conveyer is lower than the first conveyance speed and is higher than the second conveyance speed.

The invention recited in claim 6 is the ink jet recording device according to claim 5, further comprising: a slack generator that generates a slack of the base material at a conveyance downstream of the pre-process conveyer.

The invention recited in claim 7 is the ink jet recording device according to claim 6, further comprising:

a conveyance speed instructor that instructs switching between the first conveyance speed and the second conveyance speed; and

a slack detector that measures the amount of the slack at the slack generator,

wherein the conveyance speed instructor instructs the switching in accordance with a calculation result that is obtained from a measurement result by the slack detector, the conveyance speed at the pre-process conveyer, and the first conveyance speed.

The invention recited in claim 8 is the ink jet recording device according to claim 7, wherein the controller controls the printer to stop printing in response to the amount of the slack of the base material measured by the slack detector being equal to or less than a predetermined distance.

The invention recited in claim 9 is the ink jet recording device according to any one of claims 5 to 8,

wherein the base material process unit performs a corona treatment on the base material.

The invention recited in claim 10 is the ink jet recording device according to any one of claims 1 to 9, wherein

v1×T1=v2×T2

is satisfied, where v1 is the first conveyance speed, T1 is an ejection time interval of the printer at the first conveyance speed v1, v2 is the second conveyance speed, and T2 is an election time interval of the printer at the second conveyance speed v2.

The invention recited in claim 11 is the ink jet recording device according to any one of claims 1 to 10,

wherein the printer includes a head that ejects ink by using a piezoelectric element.

### Advantageous Effects of Invention

As described above, the present invention includes the single-pass ink jet printer and thereby enables printing at a speed higher than heretofore.

The controller controls the conveyor so as to change the conveyance speed of the base material at the printer between the first conveyance speed and the second conveyance speed that are different from each other. Thus, the base material can be conveyed continuously between the printing process and other process, in which the conveyance speed of the base material is different from that at the printer, although the single-pass ink jet printer can change the ejection time interval only in a stepwise manner.

Moreover, the controller forms the cut position information on the base material before start and after completion of changing the conveyance speed between the first conveyance speed and the second conveyance speed. This enables recognition of a printing defect part due to change of the speed, as a cut position.

Furthermore, by switching the conveyance speed between the first conveyance speed and the second conveyance speed, it is possible to select a select a speed that corresponds to the ejection time interval of the single-pass ink jet printer, which is the first conveyance speed or the second conveyance speed. This enables high quality printing of an image with a correct aspect ratio and no density variations.

### BRIEF DESCRIPTION OF DRAWINGS

FIG. 1 schematically illustrates a configuration of a wall paper manufacturing device according to an embodiment of the invention.

FIG. 2A is a schematic diagram of an internal structure of a head unit as viewed from the front.

FIG. 2B is a schematic diagram of an internal structure of the head unit as viewed from a printing side of a base material.

FIG. 3 is a sectional view of an ink flow path in a recording head as viewed from the front.

FIG. 4 is a block diagram illustrating primary functional components of the wall paper manufacturing device.

FIG. 5 is an explanatory diagram illustrating a relationship between an image to be printed on a base material and a printing conveyance speed.

FIG. 6 is an explanatory diagram illustrating a relationship between an image conveyance speed and timings to stop printing.

FIG. 7 is a flowchart of base material conveyance control including printing conveyance speed switching control, which is executed by a CPU of a controller.

FIG. 8 is a schematic configuration diagram illustrating another example of it base material process unit.

FIG. 9 a block diagram illustrating another example of the primary functional components of the wall paper manufacturing device.

### DESCRIPTION OF EMBODIMENTS

Overview of Embodiment of Invention

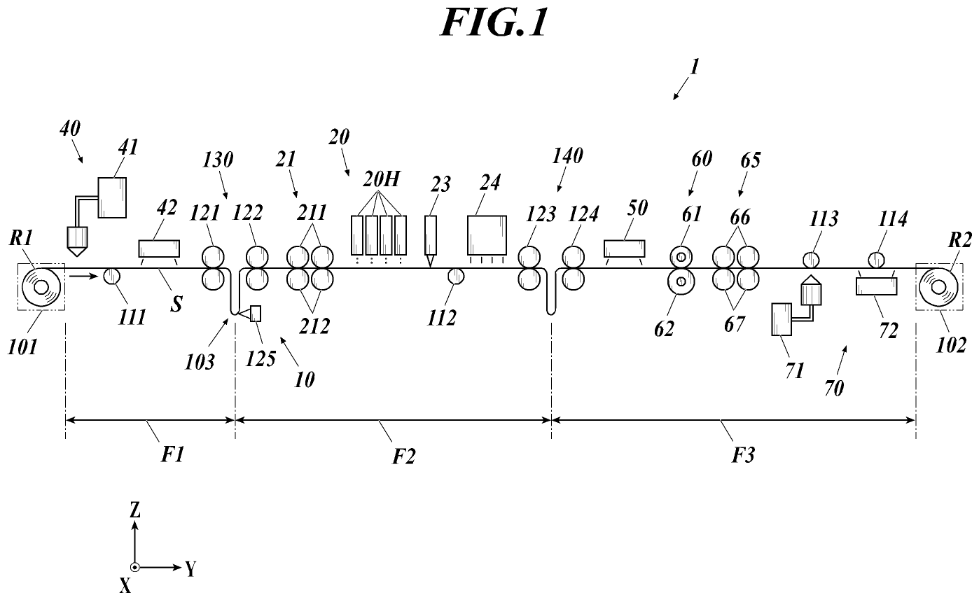

A wall paper manufacturing device 1 will be described with reference to the drawings, as an embodiment of the invention using an ink jet recording device according to the present invention. FIG. 1 is a schematic configuration diagram of the wall paper manufacturing device 1.

The wall paper manufacturing device 1 includes a feeder 101, a conveyor 10, a coater 40, a printer 20, a foaming unit 50, an embossing unit 60, an adhesive applier 70, a winder 102, and a controller 90. The feeder 101 feeds out a base material S that is a material of a wall paper. The conveyor 10 conveys the base material S in a flatly extended state. The coater 40 functions as a base material process unit for coating the base material S, which is being conveyed by the conveyor 10, with resin. The printer 20 performs printing on the base material S, which is being conveyed by the conveyor 10. The foaming unit 50 performs a foaming process on the base material S, which is being conveyed by the conveyor 10. The embossing unit 60 embosses the base material S, which is being conveyed by the conveyor 10. The adhesive applier 70 applies adhesive to the base material S, which is being conveyed by the conveyor 10. The winder 102 winds the base material S at a conveyance direction end of the conveyor 10. The controller 90 controls the printing operation and the conveying operation for the base material S.

The conveyor 10 conveys the base material S from the feeder 101 to the winder 102.

The coater 40, the printer 20, the foaming unit 50, the embossing unit 60, and the adhesive applier 70 are aligned in the written order from the upstream to the downstream of conveyance along the conveyance path of the conveyor 10 from the feeder 101 to the winder 102.

Thus, the base material S is successively subjected to a coating process, a printing process, a foaming process, an embossing process, and an adhesive applying process, in the written order, by the corresponding units while being conveyed from the feeder 101 to the winder 102 by the conveyor 10.

Base Material

The base material S for a wall paper is a long strip-shaped sheet and is in a roll R1 wound around a core before the manufacturing. The base material S is made of paper, fleece, plastic, nonwoven fabric, or other material.

In the state of the roll R1, the base material S is wound around a center axis in a direction orthogonal to the longitudinal direction of the base material S. Printing is to be performed on the surface on an outer circumferential side of the roll R1.

Feeder

The feeder 101 rotatably holds the roll R1 of the base material S in the state in which the center axis of the roll R1 is directed horizontally. The feeder 101 includes a motor and a sensor that are not illustrated in the drawing. The motor serves as a driving source for rotating the roll R1 to feed out the base material S. The sensor measures tension that is applied to the base material S pulled out from the roll R1.

The feeder 101 controls driving of the motor so as to feed out the base material S from the roll R1 in accordance with tension that is applied to the base material S as being conveyed by the conveyor 10 at the downstream in the conveyance direction.

The base material S that is fed out from the feeder 101 is conveyed by the conveyor 10 to the coater 40 for the subsequent process in the state in which its sheet surface is extended along a horizontal plane.

A fixed conveyance speed, which is described later, is equal to an appropriate conveyance speed of the base material S at the coater 40.

In the description of this embodiment, the longitudinal direction of the base material S parallel to a flat surface of the base material S, which is conveyed by the conveyor 10, is referred to as a conveyance direction or a Y direction, the direction orthogonal to the conveyance direction and parallel to the flat surface of the conveyed base material S is referred to as a width direction of the base material S or an X direction, and the direction perpendicular to the flat surface of the conveyed base material S is referred to as a Z direction.

Coater

The coater 40 forms a predetermined underlayer on a printing surface of the base material S, which is being conveyed by the conveyor 10, in order to improve the characteristics such as durability, weatherability, and plate durability. The printing surface of the base material S is an upper side of the base material S during conveyance.

The coater 40 includes an undercoat coater 41 for forming the underlayer and also includes a dryer 42 that is provided at the conveyance downstream of the undercoat coater 41.

A preferable material for forming the underlayer includes polyester resin, acrylic modified polyester resin, polyurethane resin, acrylic resin, vinyl resin, vinylidene chloride resin, polyethylene imine vinylidene resin, polyethylene imine resin, polyvinyl alcohol resin, modified polyvinyl alcohol resin, and gelatin.

The undercoat coater 41 forms the underlayer over the entire width of the printing surface or the entire printable region of the base material S by a publicly known coating method such as roll coating, gravure coating, knife coating, dip coating, or spray coating.

The dryer 42 which is disposed at the conveyance downstream of the undercoat coater 41, includes a heat source. The heat source heats the printing surface of the base material S that is coated with the underlayer by the undercoat coater 41. The dryer 42 heats and dries the underlayer coating to fix it on the base material S.

The coater 40 enables good quality printing on the printing surface of the base material S, thereby improving the image quality.

The base material S is made of fleece, paper, plastic, nonwoven fabric, or other materials. The printing surface of the base material S can be printed with good quality and can reliably have a satisfactory image quality, whichever of these materials is selected.

Printer

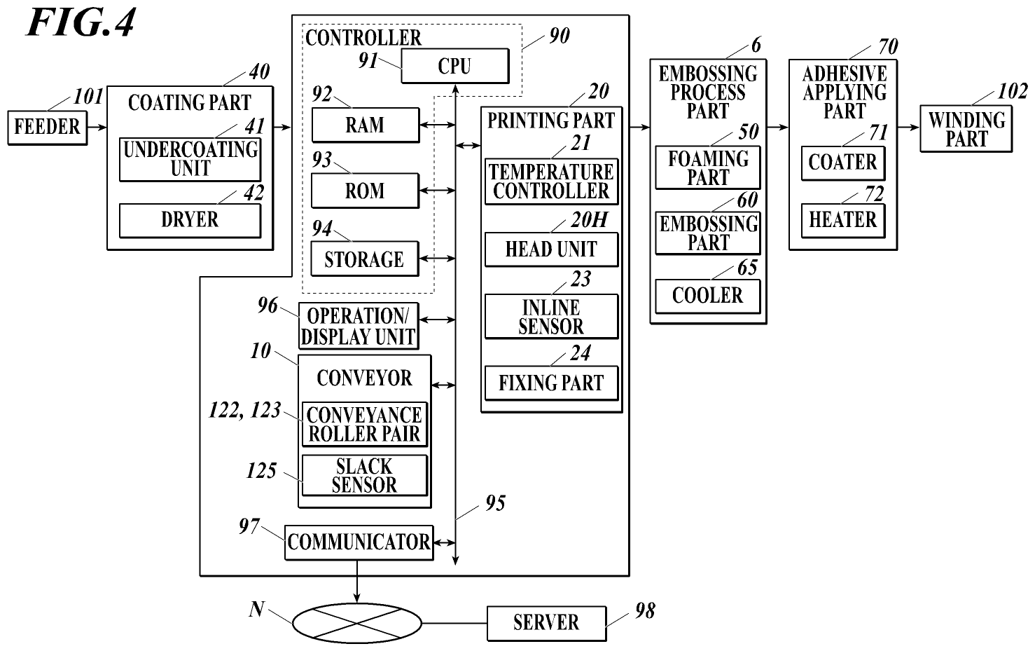

The printer 20 includes a temperature controller 21, multiple head units 20H (only one head unit 20H is illustrated in FIG. 4), an inline sensor 23, and a fixer 24. The temperature controller 21 controls the temperature of the base material S. The head units 20H form an image on the printing surface of the base material S. Such images includes patterns and colored surfaces without any pattern, and this also applies to the following descriptions. The temperature controller 21, each of the head units 20H, the inline sensor 23, and the fixer 24 are aligned side by side in the written order from the conveyance upstream to the conveyance downstream.

The temperature controller 21 includes heating rollers 211 and pressure rollers 212. The healing rollers 211 come into contact with the printing surface of the base material S, which is being conveyed by the conveyor 10. The pressure rollers 212 bring the base material S into press contact with the heating rollers 211. The conveyed base material S is made to pass through between the heating rollers 211 and the pressure rollers 212 and is thereby heated.

The heating rollers 211 are each provided with a temperature controllable heat source. A temperature sensor for measuring the temperature of the base material S, which is not illustrated in the drawing, is provided at the immediate conveyance downstream of the heating rollers 211.

On the basis of measurements of the temperature sensor, the temperature controller 21 controls heating by the controller 90 so that the temperature of the base material S is maintained at a target temperature.

The target temperature is selected to be suitable for forming a satisfactory image while avoiding undesirable phenomenon, such as occurrence of bleeding and beading of ink ejected from the head unit 20H.

The temperature controller 21 can reduce the influence of temperature change in printing, whereby a high image quality can be maintained stably.

Four head units 20H are respectively and individually provided for four color inks of yellow (Y), magenta (M), cyan (C), and black (K), for example. These head units 20H face the printing surface of the base material S and are arranged side by side at predetermined intervals in the color order of Y, M, C, and K from the conveyance upstream of the base material S. The number of the head units 20H may be three or less or live or more. In addition, the colors of the inks are not limited to those described above and can be changed as desired.

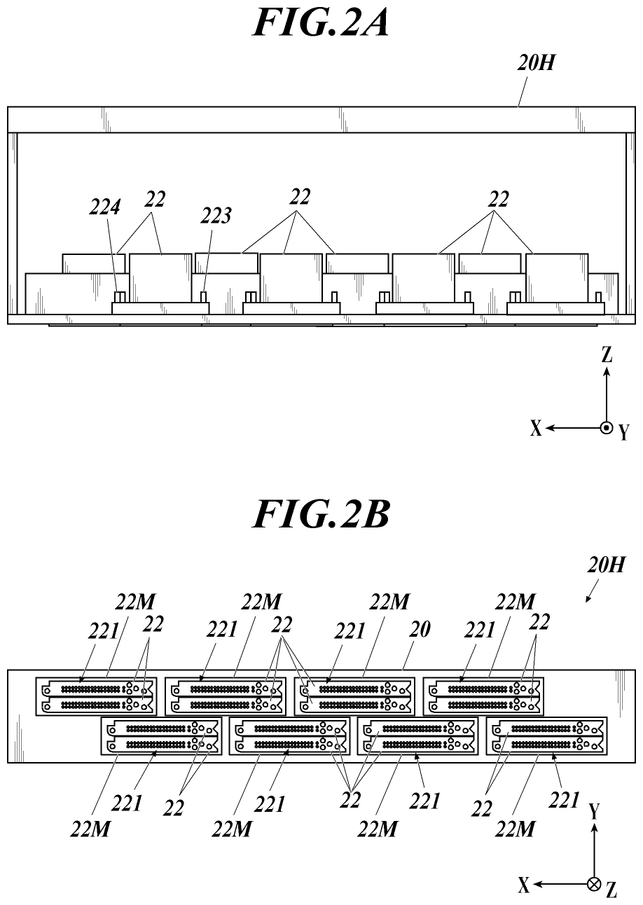

FIG. 2A is a schematic diagram of an internal structure of the head unit 20H as viewed from the front. FIG. 2B is a schematic diagram of an internal structure of the head unit 20H as viewed from the printing surface of the base material S, which is conveyed by the conveyor 10.

As used herein, viewing the head unit 20H from the front side means viewing the head unit 20H from a direction parallel to the conveyance direction of the base material S, which is conveyed by the conveyor 10.

Each of the head units 20H has multiple recording heads 22 in each of which multiple recording elements for ejecting ink are provided. The recording elements each have a pressure chamber or channel, a piezoelectric element of piezo element, an electrode, and a nozzle 221. The pressure chamber stores ink. The piezoelectric element is provided to a wall surface of the pressure chamber. The electrode is provided to apply voltage to the piezoelectric element to generate an electric field. The nozzle 221, which communicates with the pressure chamber, ejects ink in the pressure chamber. When a voltage signal with a drive waveform for deforming the piezoelectric element is applied to the electrode of the recording element, the pressure chamber is deformed in accordance with the voltage signal, and the pressure in the pressure chambers is changed. In accordance with the pressure change, the ink is ejected from the nozzle 221, which communicates with the pressure chamber. Multiple nozzles 221 are arrayed in two lines along the X direction or the width direction of the base material S and constitute two nozzle lines in the recording head 22. The two nozzle lines are staggered from each other by a half of the arrangement interval of the nozzle 221 in the X direction.

The head unit 20H includes head modules 22M as ink jetting units. Each head module 22M is a combination of two recording heads 22. The head modules 22M are arrayed in a staggered pattern. Each head module 22M has a positional relationship of the two recording heads 22 in which the nozzles 221 of the two recording beads 22 are alternately arranged in the X direction. Although the number of the head modules 22M in the head unit 20H is not specifically limited, 24 head modules 22M are provided in this embodiment. Note that only a reduced number of the head modules 22M is illustrated in FIGS. 2A and 2B. This arrangement of the recording heads 22 allows the nozzles 221 in the head unit 20H to be arranged in the X direction covering the entire width in the X direction of the printable region of the base material S, which is conveyed by the conveyor 10. The entire width in the X direction of the printable region of the base material S corresponds to the entire width or a printable width in the X direction of the base material S, the printable width being slightly narrower than the entire width. The head units 20H are used at fixed positions in recording an image. The head units 20H sequentially eject ink to different positions in the conveyance direction at predetermined intervals (conveyance direction intervals) in accordance with conveyance of the base material S, thereby recording an image in a single-pass manner.

That is the head unit 20H is a line recording head unit and does not move in a main scanning direction that is orthogonal to a sub scanning direction parallel to the base material conveyance direction, in recording an image unlike a shuttle ink jet printing.

As shown in FIG. 2A, each recording head 22 includes an inlet 223 and an outlet 224. Ink flows into the inlet 223 to be supplied to the recording head 22. The ink flows out from the outlet 224 to be discharged from the recording head 22.

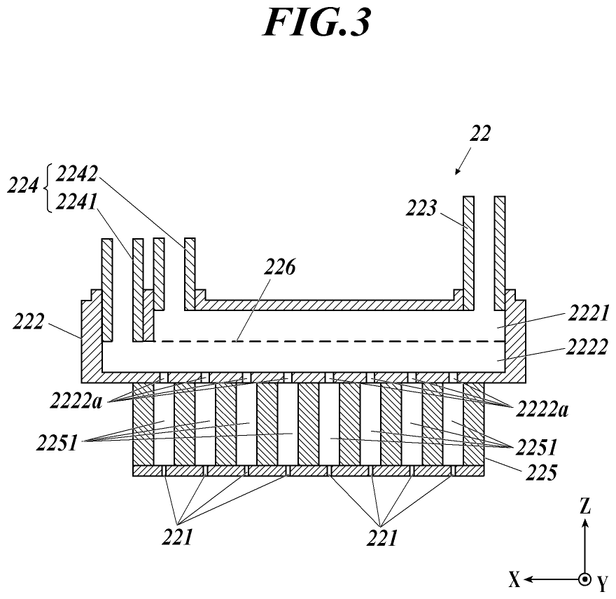

FIG. 3 is a sectional view of an ink flow path in the recording head 22 as viewed from the front.

The ink flow path in the recording head 22 includes a common ink chamber 222 and a head chip 225. The common ink chamber 222 is connected to the inlet 223 and the outlet 224. The head chip 225 ejects ink from each of the nozzles 221.

The ink flowing in from the inlet 223 is sent to the common ink chamber 222. The common ink chamber 222 is provided with a filter 226 for preventing passage of foreign matters contained in the ink. The inlet 223 communicates with an upstream ink chamber 2221 on one side of the filter 226. The outlet 224 is composed of a first outlet 2241 and a second outlet 2242. The first outlet 2241 is provided to the upstream ink chamber 2221 on the same side as the inlet 223 relative to the filter 226. The second outlet 2242 is provided to a downstream ink chamber 2222 on a side opposite to the inlet 223 across the filter 226.

The head chip 225 includes multiple element corresponding passages 2251 as pressure chambers and also includes the nozzles 221. The element corresponding passages 2251 are respectively provided to the multiple recording elements. The nozzles 221 respectively communicate with the multiple element corresponding passages 2251. Ink is ejected from an opening of each of the nozzles 221. The element corresponding passages 2251 are positioned corresponding to through holes 2222a of the downstream ink chamber 2222, whereby the ink in the common ink chamber 222 is distributed to each of the nozzles 221.

The head units 20H are individually and respectively connected to ink supply mechanisms, and respective color inks are supplied to the head units 20H.

The ink to be ejected from each of the head units 20H changes its phase between gel or solid state and liquid stale depending on temperature and has a phase transition point of from 40° C. to less than 100° C.

The inline sensor 23 is disposed at the immediate downstream of the multiple head units 20H in the conveyance direction Y of the base material S, which is conveyed by the conveyor 10. The inline sensor 23 is a line sensor capable of reading the range of the printable width of the printing surface of the conveyed base material S at a line.

Data that is read by the inline sensor 23 is input to the controller 90 and is used for inspections and detections such as inspection of image quality and a printed position of a printed image on the base material S, inspection of a printed image including an image detect inspection, and detection of abnormality in the base material S.

The inline sensor 23 enables detection of defects in a printed image on the base material S, whereby the image quality of a printed image can be maintained high.

The fixer 24 is disposed at the immediate downstream of the inline sensor 23 in the conveyance direction Y of the base material S and irradiates the printing surface of the conveyed base material S. The fixer 24 includes, for example, an ultraviolet (UV) ray source as an energy ray emitting means for emitting energy rays, such as ultraviolet rays. The fixer 24 includes multiple UV ray sources that are aligned in the X direction so as to emit energy rays to the entire width of the base material S, which is being conveyed by the conveyor 10.

The fixer 24 promotes curing of ink of an image, which is formed on the printing surface of the base material S by each of the head units 20H, and can thereby fix the image.

In the case in which a process unit for performing another process is provided at the conveyance downstream of the printer 20, the fixer 24 enables stably maintaining the image quality of a printed image c because the printed image is fixed.

Foaming Unit

The foaming unit 50 is disposed at the downstream of conveyance of the base material S relative to the printer 20. The foaming unit 50 includes a coater and a foaming furnace. The coater applies a resin material to form a layer on the printing surface of the base material S by a die coating method, a comma coating method, or other coating methods. The resin material contains a resin such as polyvinyl chloride resin or acrylic resin, and a blowing agent such as an azo compound thermally decomposable chemical blowing agent or a thermally expandable microcapsule blowing agent.

The coater applies the resin over the entire width in the X direction or at least the entire printable width of the base material S.

With this configuration, the foaming unit 50 can heat the resin layer containing the blowing agent, which is formed on the printing surface of the base material S, so as to form a foamed layer.

Embossing Unit

The embossing unit 60 is disposed at the downstream of conveyance of the base material S relative to the foaming unit 50. The embossing unit 60 includes an embossing roller 61 and a pressure roller 62. The embossing roller 61 comes into contact with the printing surface of the base material S, which is being conveyed by the conveyor 10. The pressure roller 62 brings the base material S into press contact with the embossing roller 61.

The embossing roller 61 has projections and recesses that are formed on an outer circumferential surface. The projections and recesses have a minor image of projections and recesses to be formed on the printing surface of the base material S.

The embossing roller 61 and the pressure roller 62 each have a width that allows the entire width in the X direction of the base material S to be nipped when the base material S passes between them.

At the time the base material S passes through the gap between the embossing roller 61 and the pressure roller 62 while being pressed to the embossing roller 61 by the pressure roller 62, the projections and recesses on the outer circumferential surface of the embossing roller 61 are pressed against the resin layer on the printing surface of the base material S, which is formed by the foaming unit 50. As a result, the desired projections and recesses are transferred to the resin layer.

A cooler 65 is provided at the conveyance downstream of the base material S relative to the embossing unit 60. The cooler 65 cools the resin layer, which is formed by the foaming unit 50, on the base material S conveyed by the conveyor 10.

The cooler 65 includes a cooling roller 66 and a pressure roller 67. The cooling roller 66 comes into contact with the printing surface of the base material S, which is being conveyed by the conveyor 10. The pressure roller 67 brings the base material S into press contact with the cooling roller 66.

The cooling roller 66 and the pressure roller 67 each have a width that allows the entire width in the X direction of the base material S to be nipped when the base material S passes therebetween.

The cooling roller 66 performs air cooling, water cooling, or cooling with the use of a cooling element and is made of a material having a high thermal conductivity. The resin layer on the printing surface of the base material S is brought into press contact with the cooling roller 66 by the pressure roller 67 and is thereby cooled.

This cures the resin layer while maintaining the projections and recesses formed by the embossing unit 60.

The combination of the foaming unit 50, the embossing unit 60, and the cooler 65 may be collectively called as an embossing process unit 6 (see FIG. 4).

Adhesive Applier

The adhesive applier 70 is disposed at the downstream of conveyance of the base material S relative to the foaming unit 50 and forms an adhesive layer on a back surface on the opposite side from the printing surface of the base material S (hereinafter referred to as a “back surface of the base material S”). The adhesive layer is provided to paste the base material S on a wall surface when the base material S is attached on the wall surface as a wall paper.

The adhesive applier 70 includes a coater 71 and heater 72. The coater 7 applies acrylic, rubber, or silicone sticky adhesive to form a layer on the back surface of the bast material S by a die coating method or other coating methods. The heater 72 heats the adhesive layer thus formed.

With this configuration, the adhesive layer is formed on the back surface of the base material S and is then heated to be soft, whereby the layer thickness can be easily made even.

The adhesive applier 70 may also include a release sheet attaching unit that attaches a release sheet with the same width as the base material S, on the adhesive surface of the adhesive layer of the base material S. When the base material S is rolled up in the process following to the adhesive applier 70, the release sheet is interposed between the adhesive surface of the adhesive layer and the printing surface of the base material S, thereby preventing the adhesive layer from directly adhering to the printing surface of the e base material S.

Winder

The winder 102 is disposed at the downstream of conveyance of the base material S relative to the adhesive applier 70.

The winder 102 rolls up the base material S that undergoes the coating process, the printing process, the foaming process, the embossing process, and the adhesive applying process, into a roll R2 of the base material S. The roll R2 of the base material S is rotatably held by the winder 102, in such a position that the center axis of the roll R2 is horizontal in the X direction.

The winder 102 includes a motor and a sensor that are not illustrated in the drawing. The motor serves as a driving source for rotating the roll R2 to roll up the base material S. The sensor detects slack of the base material S in front of the roll R2.

While rolling up the base material S, the winder 102 controls the speed of the motor so as to eliminate the slack in response to slack of the base material S being detected in front of the roll R2.

The winder 102 enables automatic rolling up of the base material S of the wall paper after manufacturing of the wall paper is completed. This can eliminate the need for manual operation such as a post-process of the base material S of the wall paper after manufacturing of the wall paper is completed, whereby productivity of the wall paper can be improved.

Conveyor

The conveyor 10 includes four relay rollers 1111 to 114, four conveyance roller pairs 121 to 124, conveyance motors, and encoders. The conveyance motors and the encoders are not illustrated in the drawing. The relay rollers 111 to 114 and the conveyance roller pairs 121 to 124 are aligned along the conveyance path so that that the base material S is conveyed in the conveyance path from the feeder 101 to the winder 102 while the printing surface of the base material S is maintained to be horizontal. The conveyance motors respectively and individually drive the conveyance roller parts 121 to 124. The encoders measure rotation of the corresponding conveyance motors.

The relay toilets 111 and 112 come into contact with the back, surface of the base material S from a lower side and convey the base material S to the conveyance downstream. The relay rollers 113 and 114 come into contact with the printing surface of the base material S from above and convey the base material S to the conveyance downstream.

Each of the conveyance roller pairs 121 to 124 includes an upper roller and a lower roller and conveys the base material S by nipping the base material S between the upper roller and the lower roller. The upper roller comes into contact with the printing surface of the conveyed base material S. The lower roller comes into contact with the back surface of the base material S. This structure can prevent the base material S from separating from the upper roller or the lower roller even when the rigid base material S is deflected, whereby the base material S can be stably conveyed at a target conveyance speed.

Either one of the upper roller or the lowest roller of each of the conveyance roller pairs 121 to 124 drives by the conveyance motor, and the other is driven to rotate.

The conveyance path from the feeder 101 to the winder 102 is composed of three sections: a first conveyance section F1, a second conveyance section F2, and a third conveyance section F3. The first conveyance section F1 is for conveying the base material S from the feeder 101 to a position in from of the printer 20. The second conveyance section F2 is for conveying the base material S through the whole printer 20. The third conveyance section F3 is for conveying the base material S from a position following to the printer 20 to the winder 102.

The relay roller 111 and the conveyance roller pair 121 are disposed in the first conveyance section F1 and constitute a “first conveyer” or a “pre-process conveyer”. The conveyance roller pair 121 is disposed at the conveyance downstream end of the first conveyance section F1.

The relay roller 112 and the conveyance roller pairs 122 and 123 are disposed in the second conveyance section F2 and constitute a “second conveyer”. The conveyance roller pair 122 is disposed at the conveyance upstream end of the second conveyance section F2. The conveyance roller pair 123 is disposed at the conveyance downstream end of the second conveyance section F2.

The relay roller s 113 and 114 and the conveyance roller pair 124 are disposed in the third conveyance section F3 and constitute a “third conveyer”. The conveyance roller pair 124 is disposed at the conveyance upstream end of the third conveyance section F3.

The conveyance roller pair 121, which is disposed in the first conveyance section F1, conveys the base material S at a specified conveyance speed that is referred to as a fixed conveyance speed va.

The conveyance roller pairs 122 and 123, which are disposed in the second conveyance section F2, are controlled by the controller 90 so as to cooperatively convey the base material S at a specified conveyance speed that is referred to as a printing conveyance speed. The printing conveyance speed includes two-step conveyance speeds of a first conveyance speed v1 and a second conveyance speed v2. The controller 90 approximately selects one of the two conveyance speeds and instructs the conveyance roller pairs 122 and 123 at which conveyance speed to convey the base material S.

The conveyance roller pair 124, which is disposed in the third conveyance section F3, conveys the base material S at a specified conveyance speed that is the same fixed conveyance speed as in the first conveyance section F1.

In the case in which the conveyance speed differs between the first conveyance section F1 and the second conveyance section F2, the base material S may slack between the conveyance roller pairs 121 and 122 that are disposed across a boundary between the first conveyance section F1 and the second conveyance section F2.

That is, the boundary part between the first conveyance section F1 and the second conveyance section F2 of the conveyor 10 functions as a slack generator 103 at which slack of the base material S is generated.

Similarly, in the case in which the conveyance speed differs between the second conveyance section F2 and the third conveyance section F3, the base material S may slack between the conveyance roller pairs 123 and 124 that are disposed across a boundary between the second conveyance section F2 and the third conveyance section F3.

The slack generator 103 between live conveyance roller pairs 121 and 122 is provided with a slack sensor 125. The slack sensor 125 serves a slack detector for measuring the length of slack that is generated in the base material S due to the difference between the fixed conveyance speed and the printing conveyance speed.

The slack sensor 125 optically measures the length of downward slack of the base material.

Control System of Wallpaper Manufacturing Device

FIG. 4 is a block diagram illustrating primary functional components of the wall paper manufacturing device 1.

The controller 90 includes a central process unit (CPU) 91, a random access memory (RAM) 92, a read only memory (ROM) 93, and a storage 94.

The CPU 91 reads various kinds of control programs and setting data that are stored in the ROM 93, loads the read information in the RAM 92, and executes these programs to perform various kinds of arithmetic processing. Moreover, the CPU 91 integrally controls the overall operation of the wall paper manufacturing device 1.

The RAM 92 provides a working memory space for the CPU 91 and stores temporary data. The RAM 92 may include a non volatile memory.

The ROM 93 stores various kinds of control programs to be executed by the CPU 91 and stores setting data. A rewritable nonvolatile memory, such as an electrically erasable programmable read only memory (EEPROM) or a flash memory, maybe used instead of the ROM 93.

The storage 94 stores image data relating to an image to be printed on the base material S by the printer 20 and also stores various kinds of setting data. The storage 91 may be configured as, for example, a hard disk drive (HDD), and a dynamic random access memory (DRAM) may be used together.

As described above, the wall paper manufacturing device 1 includes the feeder 101, the undercoat coater 41 and the dryer 12 of the coater 40, the temperature controller 21, the four head units 20H (only one head unit 20H is illustrated in the drawing), the inline sensor 23, and the fixer 24 of the coater 40, the embossing process unit 6, the coater 71 and the heater 72 of the adhesive applier 70, the winder 102, and the conveyance roller pairs 121 to 124 and the slack sensor 125 of the conveyor 10.

Among these components, each component of the printer 20, and the conveyance roller pairs 122 and 123 and the slack sensor 125 of the conveyor 10, are connected to the controller 90 via a bus 95 and are configured to mutually transmit and receive signals. Each of these components is connected to the controller 90 via an interface, which is not illustrated in the drawing.

Moreover, an operation/display unit 96 and a communicator 97 are connected to the controller 90 via the bus 95 and an interface, which is not illustrated in the drawing.

The operation/display unit 96 includes a display, such as a liquid crystal display or an organic EL display, and includes an input interface, such as an operation key or a touch panel overlaid on a screen of the display. The operation/display unit 96 displays various kinds of information on the display. Further, the operation/display unit 96 converts an input of a user on the input interface into an operation signal and outputs the operation signal to the controller 90.

The communicator 97 establishes a communication between an external device and the controller 90 via a communication network N. An example of the external device includes a server 98.

In one example, the controller 90 communicates with the external server 98 via the communication network N, thereby acquiring image data for printing from the server 98. The controller 90 stores the acquired image data in the storage 94 and performs printing on the base material S based on the image data. This allows easy and speedy retrieval of a larger variety of pattern images for a wall paper, and various wall papers can therefore be easily manufactured.

Base Material Conveyance Control

Conveyance control of the base material S that is performed by the controller 90 will be described.

Since each of the head units 20H of the printer 20 is a line recording head unit that records an image in a single-pass manner, the wall paper manufacturing device 1 can perform printing on the printing surface of the base material S at a speed higher than heretofore. Accordingly, the conveyance speed of the base material S can also be increased.

Meanwhile, the printer 20 performs printing by using the head units 20H with piezoelectric elements, and therefore, an ejection time interval is limited by a resonance time (AL) that depends on the structure of the head unit 20H. For example, if a head unit 20H has a resonance time AL of 2 μsec, the minimum ejection time interval for appropriately ejecting ink is 5 AL, the second minimum ejection time interval is 7 AL, and the subsequent minimum ejection time intervals are discontinuous and determined by odd number times of AL. If such a relationship between the ejection time interval and the resonance time AL is not considered, it is difficult to achieve appropriate ejection. For example, the amount of liquid may be decreased or satellites may be increased. That is, the printing conveyance speed of the printer 20 is determined by the ejection time interval and a recording density or dot interval and cannot be continuously changed as with the ejection time interval because the recording density is fixed. Thus, it is difficult to set the printing conveyance speed to a freely selected speed.

On the other hand, the coater 40 of a first process unit and the foaming unit 50, the embossing unit 60, and the adhesive applier 70 of a third process unit have their respective appropriate conveyance speeds, and the fixed conveyance speed va is a conveyance speed common to these units. Meanwhile, the printing conveyance speed is desirably limited to any one of speeds that are determined by dividing the recording density or the dot interval by an odd number of 5 or greater×the resonance time AL, as described above, and therefore, it is difficult to completely match the printing conveyance speed with the fixed conveyance speed va.

For this reason, the controller 90 uses a first conveyance speed v1 and a second conveyance speed v2 as shown by the following formula (1), as the printing conveyance speed. The first conveyance speed v1 is higher than the fixed conveyance speed va and is, for example, the recording density/5 AL. The second conveyance speed v2 is lower than the fixed conveyance speed va and i, for example, the recording density/7 AL. The controller 90 controls the conveyance roller pairs 121 and 123 of the conveyor 10 so as to switch between the first conveyance speed v1 and the second conveyance speed v2 in accordance with the state of a slack generated in the base material S.

(First conveyance speed v1)>(Fixed conveyance speed va)>(Second conveyance speed v2) (1)

With the speed switching control, it is possible to prevent the occurrence of excessive tension or excessive slack of the base material S even when the conveyance speed of the continuous base material S differs between the conveyance sections F1 to F3.

When the second conveyer conveys the base material S at the first conveyance speed v1 in the conveyance section F2, the slack of the base material S between the conveyance sections F1 and F2 is reduced while the slack between the conveyance sections F2 and F3 is increased. When the second conveyor conveys the base material S at the second conveyance speed v2 in the conveyance section F2, the slack of the base material S between the conveyance sections F1 and F2 is increased while the slack between the conveyance sections F2 and F3 is reduced.

To cope with this, the controller 90 measures the slack length of the base material S by using the slack sensor 125 and performs the speed switching control to switch the printing conveyance speed in accordance with the measured slack length of the base material S. Details of this operation will be described later.

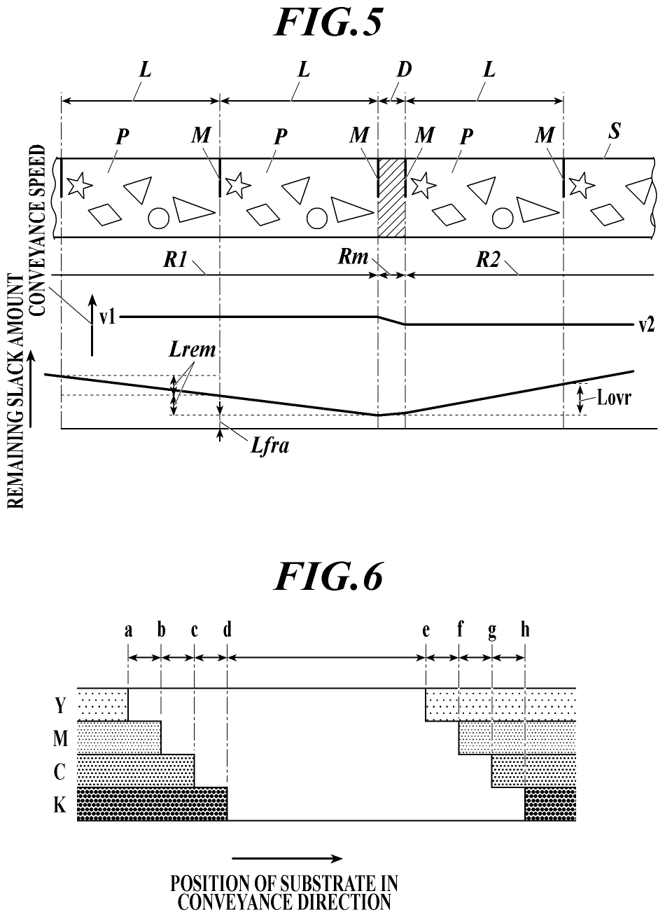

A relationship between an image to be printed on the base material S and the printing conveyance speed is illustrated in FIG. 5. A relationship between the printing conveyance speed and timings to stop printing by the multiple head units 20H is illustrated in FIG. 6.

On the printing surface of the base material S, which is a material of the wall paper, an image having a distance L and containing a pattern image P is repeatedly printed in the conveyance direction. The repeated images each having the distance L and containing the pattern image P are continuously formed over each length L in the conveyance direction. Multiple smaller pattern images P may be continuously formed within a length L, or a blank may be contained within a length L.

In the case of continuously forming the repeated images each having the distance L and containing the pattern image P, a cut mark M as cut position information is formed at a termination end of each repeated image having the distance L.

The cut mark M is intended as a reference for a cut position after printing is completed. The controller 90 basically controls the printer 20 so that the cut mark M is formed at each termination end of the repeated images each having the distance L and containing the pattern image P that are formed side by side in the conveyance direction Y. Accordingly, the cut mark M is formed on the printing surface of the base material S every distance L. The cut mark M as cut position information may have any shape that can be visually identified is the cut position, such as a line, a dot, an edge of a figure, a pattern, or a printed region, a boundary indicated by difference in color, or a predetermined marking.

As described above, conveyance in the second conveyer is alternately switched between the first conveyance speed v1 and the second conveyance speed v2 in order to correspond to the fixed conveyance speed va at the upstream and the downstream of conveyance of the base material.

During the period of changing the speed from the first conveyance speed v1 to the second conveyance speed v2 or from the second conveyance speed v2 to the first conveyance speed v1, it is difficult to maintain the correspondence between the ejection time interval and the resonance time AL. This can cause variations in the amount of ejected liquid, generation of satellites, and other undesirable phenomena, as described above, and it is therefore difficult to maintain the image quality, the density, the resolution, and other characteristics at a constant level.

In view of this, the controller 90 controls the printer 20 and the conveyance roller pairs 122 and 123 of the conveyor 10 cooperatively so that the speed is switched from the first conveyance speed v1 to the second conveyance speed v2 or from v2 to v1 within a period between the conveyance of the distance L of a repeated image containing the pattern image P and the conveyance of the distance L of the next repeated image containing the pattern image P in order any pattern image P not to be formed during the change of the conveyance speed.

As described above, the printer 20 cannot appropriately eject ink due to the structure of the head unit 20H using the piezoelectric elements unless the ejection time interval is set to a product of an odd number of 5 or more and the resonance time AL.

On the other hand, even in the case of changing the ejection time interval, the same recording density or the dot interval must be maintained in order to maintain the same aspect ratio of an image.

For this reason, the first conveyance speed v1 and the second conveyance speed v2 am selected so as to satisfy the lot lowing equation, where T1 is the ejection time interval of the printer 20 at the first conveyance speed v1, and T2 is the ejection time interval of the printer 20 at the second conveyance speed v2.

v1×T1=v2×T2=Recording density.

Each of the ejection time intervals T1 and T2 is the product of an odd number of 5 or more and the resonance time AL, as described above. The embodiment illustrates an example in which the ejection time interval T1=5 AL, and the ejection time interval T2=7 AL.

As illustrated in FIG. 5, R1 is a conveyance region of the base material S conveyed at the first conveyance speed v1, R2 is a conveyance region conveyed at the second conveyance speed v2, and Rm is a speed changing region in which the speed is being changed from v1 to v2 or from v2 to v1.

The speed changing region Rm of the base material S is not used as a wall paper. Thus, the printer 20 is controlled to form a cut mark M at a termination end of the repeated image having the distance L and containing the pattern image P that is at the conveyance upstream of the speed changing region Rm and at a start end of the repeated image having the distance L and containing the pattern image P that is at the conveyance downstream of the speed changing region Rm. This allows the speed changing region Rm having the length D of the base material S to be cut away at a later lime after the wall paper is formed, where D is the length of the speed changing region Rm.

As described above, in a transition from the conveyance region R1 or R2 to the speed changing region Rm, each of the head units 20H stops ejecting ink at the termination end of the repeated image having the distance L and containing the pattern image P.

More specifically, as illustrated in FIG. 6, in the case in which the head units 20H are arranged at an interval of a pitch Lp, in the order of yellow (Y), magenta (M), cyan (C), and black (K) from the conveyance upstream of the base material S, the operation of the yellow (Y) head unit 20H printing a termination end of the repeated image having the distance L and containing the pattern image P with respect to the base material S is stopped at a base material position a in the conveyance direction.

Next, the operations of the magenta (M), cyan (C), and black (K) head units 20H printing the termination end of the repeated image having the distance L and containing the pattern image P are sequentially stopped at base material positions b, c, and d in the conveyance direction of the base material S, respectively.

At least one of the head units 20H ejects ink to form a cut mark M immediately in front of the corresponding base material position a, b, c, or d in the conveyance direction.

The printing operations of all of the head units 20H are stopped when the head unit 20H at the downstream end has passed the base material position d in the conveyance direction. Then, the speed is changed between the first conveyance speed v1 and the second conveyance speed v2 before the base material S reaches a position e at which a start end of the next repeated image having the distance L and containing the pattern image P passes an ejection position of yellow (Y). Thus, all of the head units 20H print a cut mark on the base material and pass the cut mark at the first conveyance speed.

Thereafter, when the base material S reaches the base material position c in the conveyance direction, at which a start end of the next repeated image having the distance L and containing the pattern image P passes the ejection position of yellow (Y), the corresponding head unit 20H resumes the printing operation. Thereafter, when the start end of the repealed image having the distance L and containing the pattern image P of the base material S sequentially passes the ejection positions of the magenta (M), cyan (C), and black (K) head units 20H respectively at base material positions f, g, and h in the conveyance direction, the corresponding head units 20H sequentially resume the printing operations.

Each of the head units 20H ejects ink to form a cut mark M immediately behind the base material positions, e, f, g, or h in the conveyance direction. Thus, all of the head units 20H print the cut mark on the base material after the speed is changed to the second conveyance speed.

Specific Processing of Base Material Conveyance Control

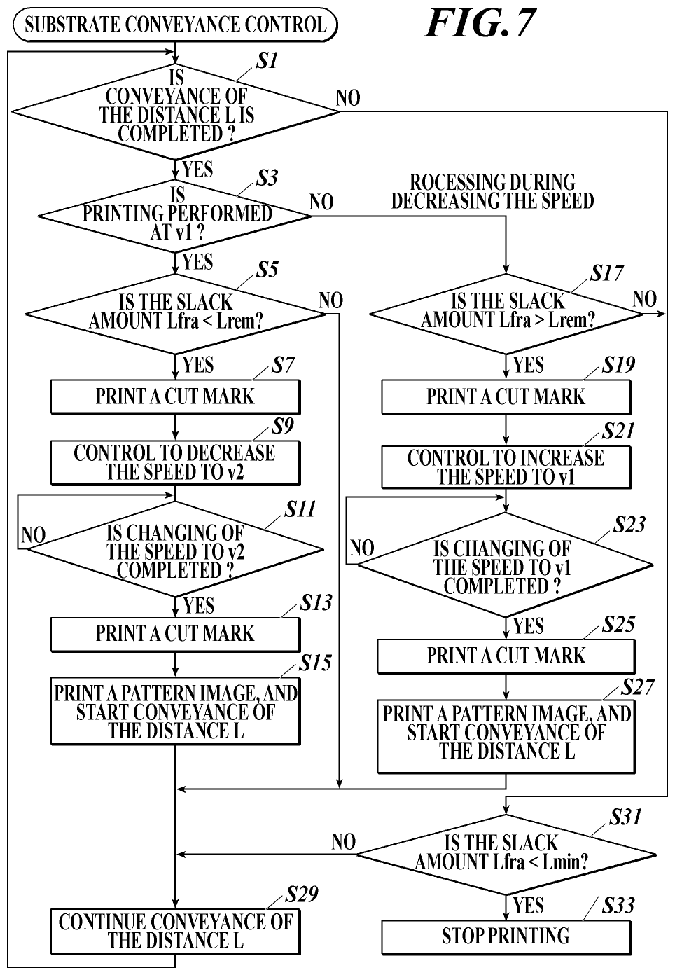

The base material conveyance control including the printing conveyance speed switching control, which is executed by the CPU 91 of the controller 90, will be described with reference to FIG. 5 and a flowchart illustrated in FIG. 7.

The base material S is conveyed by the conveyor 10. The base material S is subjected to the coating process while being conveyed at the fixed conveyance speed va at the first process unit. The base material S is subjected to the printing process while being conveyed at the putting conveyance speed v1 or v2 at the second process unit. The base material S is successively subjected to the foaming process, the embossing process, and the adhesive applying process, while being conveyed at the fixed conveyance speed va at the third process unit.

In the initial state, slack of a predetermined length is preliminarily formed in the base material S between the first conveyance section F1 and the second conveyance section F2, but slack is not formed in the base material S between the second conveyance section F2 and the third conveyance section F3.

In these conditions, the CPU 91 determines whether a termination end of the repeated image containing the pattern linage P is conveyed by the distance L, nod reaches a position at or slightly in front of the ejection position of the most upstream yellow (Y) head unit 20H, in the second conveyance section F2 (Step S1). Precisely, the termination end is desirably a part slightly in front of the termination end. In addition, the ejection position of the head unit 20H is the ejection position of the most upstream nozzle in the unit.

The conveyance of the distance L of the repeated image containing the pattern image P can be measured by a device such as the encoder or a sensor. The encoder is provided to the motor for driving the conveyance roller pair 122 in the second conveyance section F2 to measure the conveyance distance of the base material S. The sensor optically measures the conveyance distance of the base material S.

If the conveyance of the distance L of the repeated image containing the pattern image P of the base material S has not been performed in the second conveyance section F2 (Step S1: NO), the CPU 91 determines whether a slack length Lfra of the base material S measured by the slack sensor 125 becomes less than a predetermined minimum distance Lmin (Step S31). If the slack length Lfra is less than the distance Lmin, the CPU 91 understands that conveyance malfunction occurs due to any cause, and stops printing by the printer 20 (Step S33).

If the slack length Lfra is equal to or greater than the minimum distance Lmin, the CPU 91 continues printing and conveyance at the printing conveyance speed v1or v2 without any change (Step S29).

If the termination end of the repeated image having the distance L and containing the pattern image P reaches the second conveyance section F2 (Step S1: YES), the CPU 91 determines whether the current printing conveyance speed is the first conveyance speed v1 (Step S3).

If the conveyance is performed at the first conveyance speed v1 (Step S3: YES), this means the slack length Lfra of the base material S between the first conveyance section F1 and the second conveyance section F2 will be decreased, and therefore, the CPU 91 determines whether the remaining slack length Lfra becomes less than a determination value (lower limit) Lrem (Step S5).

The slack length determination value Lrem will be described below with reference to FIG. 5.

The slack length determination value Lrem represents a slack length of the base material S between the first conveyance section F1 and the second conveyance section F2 that is reduced while the repeated image having the distance L and containing the pattern image P is printed at the first conveyance speed v1.

The slack length determination value Lrem is calculated from the following equation (2).

Lrem=L−(va*L/v1) (2)

As described above, the conveyance speed switching control is not executed during conveyance of the distance L of the repeated image containing a single pattern image P. Each time conveyance of the distance L is performed, it is necessary to determine whether the remaining slack length Lfra of the base material S between the first conveyance section F1 and the second conveyance section F2 is greater than the slack length determination value Lrem that is reduced in forming each pattern image P.

If conveyance of the distance L of the next repeated image containing the pattern image P was started at the first conveyance speed v1 in the state in which the remaining slack length Lfra is less than the slack length determination value Lrem to be consumed by the conveyance, the remaining slack length Lfra would be completely consumed before the conveyance of the distance L of the repeated image containing the pattern image P is finished. This causes the base material S between the first conveyance section F1 and the second conveyance section F2 to be excessively pulled by the second conveyer.

In order to avoid this, it the remaining slack length Lfra is less than the determination value Lrem (Step S5: YES). the CPU 91 performs a control to print a cut mark M (Step S7) and executes the printing conveyance speed switching control to as to decrease the speed from the first conveyance speed v1 to the second conveyance speed v2 (Step S9).

Otherwise, if the remaining slack length Lfra is equal to or greater than the determination value Lrem (Step S5: NO), conveyance of the distance L of the next repeated image containing the pattern image P is performed still at the first conveyance speed v1 (step S29).

Once the printing conveyance speed starts to be decreased by the printing conveyance speed switching control in step S9, the CPU 91 repeats determination of whether the printing conveyance speed has been decreased to the second conveyance speed v2 (Step S11). It the printing conveyance speed has been decreased to the second conveyance speed v2 (Step S11: YES), the CPU 91 prints a cut mark M (Step S13), and starts conveyance of the distance L of the next repeated image containing the pattern image P at the second conveyance speed v2 (Step $15).

In the subsequent steps, the CPU 91 continues the conveyance of the distance L of the repeated image containing the pattern image P is continued (Step S29), and then returns to step S1 in order to monitor arrival of a termination end of the repeated image having the distance L and containing the pattern image P.

In step S3, if the current printing conveyance speed is the second conveyance speed v2 (Step S3: NO), the slack length Lfra of the base material S between the first conveyance section F1 and the second conveyance section F2 will be increased, and therefore, the CPU 91 determines whether the slack length Lfra becomes greater than the determination value (upper limit) Lrem (Step SI7).

The slack length determination value Lrem represents a slack length of the base material S between the first conveyance section F1 and the second conveyance section F2 that is reduced while rise repeated image containing the pattern image P is conveyed by the distance L at the first conveyance speed v1, as described above.

While the base material S is conveyed at a set printing conveyance speed of the second conveyance speed v2, the slack length of the base material S between the first conveyance section F1 and the second conveyance section F2 is increased. Thus, before the speed is switched back to the first conveyance speed v1, it is necessary to store a slack length of the base material S that allows conveyance of at least the distance L of the repeated image containing the pattern image P.

For this reason, the determination value (upper limit) at the second conveyance speed v2 is not limited to Lrem and may be equal to or greater than Lrem.

For example, in a case in which the determination value (upper limit) at the second conveyance speed v2 is n times of Lrem (n is a natural number), slack is stored to a length of n times of Lrem or longer Accordingly, the speed switching control is performed each time the n number of the pattern images P are successively formed.

If the slack length Lfra of the base material S becomes greater than the determination value (upper limit) Lrem (Step S17: YES), the CPU 91 performs a control to print a cut mark M (Step S19) and executes the printing conveyance speed switching control so as to increase the speed from the second conveyance speed v2 to the first conveyance speed v1 (Step S21).

If the slack length Lfra is less than the determination value Lrem (Step S17: NO), the CPU 91 further determines whether the slack length Lfra is less than the minimum distance Lmin (Step S31). If the slack length Lfra is less than the distance Lmin, the CPU 91 stop printing by the printer 20 (Step S33). Otherwise, if the slack length Lfra is equal to or greater than the minimum distance Lmin, the CPU 91 performs conveyance of the distance L of the next repeated image containing the pattern image P still at the second conveyance speed v2 (Step S29).

Once the printing conveyance speed starts to be increased by the printing conveyance speed switching control in step S21, the CPU 91 repeats determination of whether the printing conveyance speed has been increased to the first conveyance speed v1 (Step S23). If the printing conveyance speed has been increased to the first conveyance speed v1 (Step S23: YES), the CPU 91 prints a cut mark M (Step S25), and starts conveyance of the distance L of the next repeated image containing the pattern image P in the first conveyance speed v1 (Step S27).

In the subsequent steps, the CPU 91 continues the conveyance of the distance L of the repeated image containing the pattern image P (Step S29), and then returns to Step S1 in order to monitor arrival of a termination end of the repeated image containing the pattern image P after conveyance is performed by the distance L.

Conveyance of the base material S is performed at the fixed conveyance spreed va in the third conveyance section F3 as in the case of the first conveyance section F1. Thus, the slack length of the base material S between the second conveyance section F2 and the third conveyance section F3 is increased and decreased in an inverse relation to the slack length of the base material S between the first conveyance section F1 and the second conveyance section F2.

That is, while the slack length of the base material S between the first conveyance section F1 and the second conveyance section F2 is increased, the slack length of the base material S between the second conveyance section F2 and the third conveyance section F3 is decreased, whereas while the slack length of the base material S between the first conveyance section F1 and the second conveyance section F2 is decreased, the slack length of the base material S between the second conveyance section F2 and the third conveyance section F3 is increased.

Thus, the slack of the base material S between the second conveyance section F2 and the third conveyance section F3 is controlled in a manner similar to the slack of the base material S between the first conveyance section F1 and the second conveyance section F2, whereby pulling and generation of excessive slack of the base material S are prevented.

### Technical Effects of Embodiment of Invention

In the wall paper manufacturing device 1, the conveyor 10 conveys the base material S in the state of being extended in the width direction over the entire conveyance path, and the printer 20 performs printing by using the single-pass ejection structure on the base material S that is being conveyed by the conveyor 10. This configuration enables the printer 20 to convey the base material S at a speed higher than heretofore.

Thus, it is not necessary to set the conveyance speed of the base material S at the coater 40, the foaming unit 50, the embossing unit 60, or the adhesive applier 70, each of which is provided in the conveyance path as the base material process unit, to a low speed in accordance with a shuttle ink jet printer as in conventional devices. This enables the wall paper manufacturing device 1 to manufacture a wall paper at a high speed.

In the wall paper manufacturing device 1, the controller 90 controls the conveyor 10 such that the printing conveyance speed is changed between the first conveyance speed v1 and the second conveyance speed v2. Thus, although the printer 20 is a single-pass ink jet printer for which it is difficult to continuously change the ejection time interval to a freely selected time interval, the base material S can be continuously conveyed between the printer 20 and the first conveyance section F1 or the third conveyance section F3 at which the conveyance speed of the base material S is different from that at the printer 20.

Moreover, the controller 90 controls the printer 20 to form a cut mark M on the base materiel S before start and after completion of changing the printing conveyance speed between the first conveyance speed v1 and the second conveyance speed v2. This enables identification of a part where it is difficult perform printing due to change of the speed, as a cut position.

The first conveyance speed v1 and the second conveyance speed v2 are selected from speeds that correspond to the ejection time interval of the single-pass ink jet printer 20. This enables high quality printing of an image with a correct aspect ratio and no density variations (uneven density).

The controller 90 of the wall paper manufacturing device 1 functions as a conveyance speed instructor that instructs switching between the first conveyance speed v1 and the second conveyance speed v2 in accordance with the result of calculation represented by the formula (2). The calculation result is obtained limit the slack length of the base material S between the first conveyance section F1 and the second conveyance section F2, which is measured by the slack sensor 125, the fixed conveyance speed in as the conveyance speed at the pre-process conveyer, and the first conveyance speed v1. This function enables more appropriate switching of the conveyance speeds.

The controller 90 controls the conveyance roller pairs 122 and 123 of the conveyor 10 such that the conveyance speed is changed between the first conveyance speed v1 and the second conveyance speed v2 after the repeated image having the distance L and containing the pattern image P is formed but before the next repeated image having the distance L and containing the pattern image P is formed. This can avoid low printing image quality during change of the conveyance speed, and therefore, printing can be performed while maintaining a high image quality.

The speed changing region Rm with the length D, where the conveyance speed is changed, has cut marks M at both ends and thereby can be easily removed after printing is completed.

The wall paper manufacturing device 1 includes the relay roller 111 and the conveyance roller pair 121 as the pre-process conveyer and includes the coater 40. The pre-process conveyer conveys the base material S in a flatly extended state in the first conveyance section F1 at the conveyance upstream of the conveyor 10. The coater 40 performs the coating process on the base material S that is being conveyed by the relay roller 111 and the conveyance roller pair 121. The fixed conveyance speed va in the first conveyance section F1 is lower than the first conveyance speed v1 and is higher than the second conveyance speed v2.

Thus, although slack of the base material S is increased and decreased between the first conveyance section F1 and the second conveyance section F2, the base material S is protected since pulling and generation of excessive slack of the base material S are prevented, while the appropriate conveyance speed v1 or v2 is maintained at the single-pass ink jet printed 20. As a result, conveyance can be performed while maintaining a good printed image.

In the wall paper manufacturing device 1, assuming that the ejection time interval of the printer 20 at the first conveyance speed v1 is T1, and the ejection time interval of the printer 20 at the second conveyance speed v2 is T2, the controller 90 controls the second conveyer and the printer 20 so as to satisfy v1×T1=v2×T2.

Thus, the recording density and the aspect ratio of an image can be maintained at a constant level even at different conveyance speeds. As a result, the quality of a formed image can be maintained at a constant level although change of the conveyance speed is performed.

In the wall paper manufacturing device 1, the controller 90 controls the printer 20 to stop printing when the slack amount of the base material S measured by the slack sensor 125 becomes the preliminary specified distance Lmin or less. Thus, emergency stop can be wide when slack of the base material S is excessively decreased. When any abnormality occur, this can prevent pulling of the base material S and abnormal printing and can thereby protect the base material S.

Other Examples of Base Material Process Unit

The wall paper manufacturing device 1 includes the coater 40 as the base material process unit that is disposed in the first conveyance section F1. However, the base material process unit is not limited to this example.

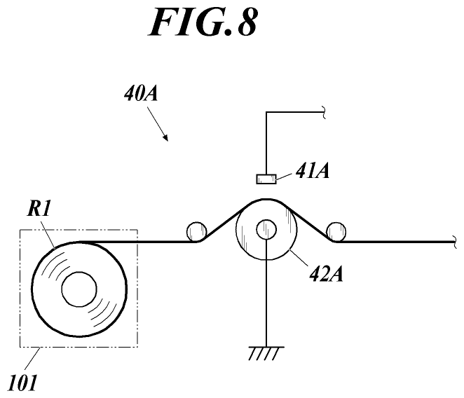

For example, as illustrated in FIG. 8, a corona treatment unit 40A may be provided as the base material process unit.

The corona treatment unit 40A is composed of a dielectric roller 42A and an electrode 41A. The dielectric roller 42A is grounded and is configured to come into press contact with the back surface of the base material S. The electrode 41A is disposed so as to closely face the printing surface of the base material S at the press contact position of the dielectric roller 42A. The electrode 41A is connected to a high-frequency high-voltage power supply. This structure makes accelerated electrons that are generated by a corona discharge, collide with the printing surface of the passing base material S, thereby modifying the printing surface of the base material S and improving printability.

The coater 40 and the corona treatment unit 40A may be disposed together as the base material process unit. In this case, it is desirable to dispose the coater 40 at the conveyance upstream of the corona treatment unit 40A so that the formed underlayer is modified.

Other Examples of Primary Functional Components of Wake Paper Manufacturing Device

In the wall paper manufacturing device 1, the controller 90 controls only the conveyor 10 in the second conveyance section and the printer 20, and the feeder 101, the conveyor 10 in the first and the third conveyance sections, the coater 40, the embossing process unit 6, the adhesive applied 70, and the winder 102 are independently driven to perform a printing operation. However, the control method is not limited to this example.

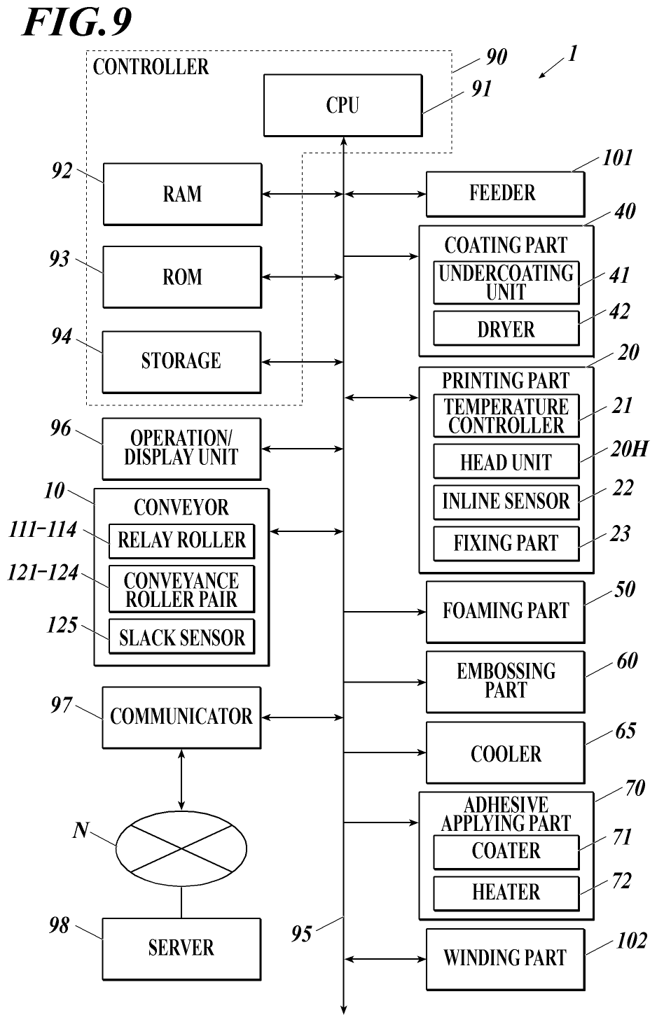

In another example as illustrate in FIG. 9, the controller 90 may be connected through a bus to all of the conveyance roller pairs 121 to 124 of the conveyor 10, the printer 20, the feeder 101, the coater 40, the foaming unit 50, the embossing unit 60 and the cooler 65 of the embossing process unit 6, the adhesive applier 70, and the winder 102, via an interface, which is not illustrated in the drawing, and the controller 90 may be configured to transmit and receive control signals and other signals to and from these components.

In this case, the controller 90 can perform a control to cooperatively operate the feeder 101, the coater 40, the embossing process unit 6, the adhesive applier 70, and the winder 102 so as to integrally control them when executing each process in the wall paper manufacturing. Further, the conveyance speeds of the conveyor 10 in the first and the third conveyance sections can also be controlled by the controller 90.

The control method is not limited to the method in which the controller 90 integrally controls all of the components. each of the feeder 101, the conveyor 10, the coater 40, the embossing process unit 6, the adhesive applier 70, and the winder 102 may have an individual controlling unit, and these controlling units may communicate with the controller 90 to perform a cooperative control, thereby executing each process in the wall paper manufacturing.

Others

Although embodiments of the present invention are described above, the scope of the present invention is not limited to the foregoing embodiments and includes the scope of the invention recited in claims and the scope of its equivalents.

For example, on the condition that the first conveyance speed v1 is higher than the fixed conveyance speed va, and the second conveyance speed v2 is lower than the fixed conveyance speed va, the ejection time interval at the first conveyance speed v1 and the ejection time interval at the second conveyance speed v2 are not limited to respectively 5 AL and 7 AL. These numbers can be any odd number of 5 or greater.

In addition, on the condition that the first conveyance speed v1 is higher than the fixed conveyance speed va, and the second conveyance speed v2 is lower than the fixed conveyance speed va, the first conveyance speed v1 and the second conveyance speed v2 are desirably close to the fixed conveyance speed va as much as possible, and accordingly, more appropriate values should be selected from among odd numbers of 5 or greater, for the ejection time intervals.

The wall paper manufacturing device 1 uses ink that is cured by ultraviolet rays, as an example. However, active ray curing ink that can be cured by any other active my other ultraviolet ray may be used, or other ink having a characteristic of viscosity changing by heat, may be used.

A coater for applying coating that protects the printed printing surface of the base material S, may be provided at the conveyance downstream of the printer 20 separately from the coater 40.

Each of the foaming unit 50, the embossing unit 60, the cooler 65, and the adhesive applier 70 is not essential, and one or more of them may be omitted from the configuration of the wall paper manufacturing device.

One or both of the foaming unit 50 and the embossing unit 60 may be disposed in the first conveyance section F1. In this case, the coater 40 may be omitted.

A laminator for cutting the base material S into a predetermined length and laminating the cut base materials S may be provided instead of the winder 102. For example, the predetermined cut length is integer times of the repetition length L described above. In this case, it is desirable to provide a release sheet attaching unit that attaches a release sheet on the adhesive surface of the adhesive layer of the base material S, at the conveyance upstream of the laminator.

The foregoing embodiments are examples in which the ink jet printing recording device is applied to the wall paper manufacturing device. However, the application is not limited to the wall paper manufacturing device. The ink jet recording device that performs specific controls of the printer 20 and the conveyor 10 can be used in any applications for forming a predetermined image on a long sheet-shafted base material along a conveyance direction.

The coater 40, the foaming unit 50, the embossing unit 60, and the adhesive applier 70 are described as examples of the base material process unit. However, components that perform each process that accompanies image formation on a long sheet-shaped base material, can also be used as the base material process unit, in addition to the components for performing processes relating to the wall paper manufacturing.

### INDUSTRIAL APPLICABILITY

The ink recording device according to the present invention is industrially applicable to an ink jet recording device that performs printing on a long sheet-shaped base material.

### REFERENCE SIGNS LIST

1 wall paper manufacturing device (ink jet recording device)

6 embossing process unit

10 conveyor

111 to 114 relay rollers

121 to 124 conveyance roller pairs

125 slack sensor

20 printer

20H head unit

22 recording head

22M head module

40 coater (base material process unit)

40A corona treatment unit (base material process unit)

50 foaming unit (base material process unit)

60 embossing unit (base material process unit)

70 adhesive applier (base material process unit)

90 controller (conveyance speed instruction unit)

91 CPU

221 nozzle

F1 first conveyance section

F2 second conveyance section

F3 third conveyance section

M cut mark (cut position information)

P pattern image

Rm speed changing region

S base material

v1 first conveyance speed

v2 second conveyance speed

va fixed conveyance speed

1. An ink jet recording device comprising:
a conveyer that conveys a long sheet-shaped base material in a flatly extended state;
a single-pass ink jet printer that ejects ink from multiple nozzles that are arranged in a width direction of the base material, so as to performs printing on the base material conveyed by the conveyer; and
a controller that controls the conveyer to change a conveyance speed of the base material relative to the printer between a first conveyance speed and a second conveyance speed that are different from each other,
wherein the controller controls the printer to form cut position information on the base material before start of changing the conveyance speed between the first conveyance speed and the second conveyance speed and after completion of changing the conveyance speed between the first conveyance speed and the second conveyance speed.

2. The ink jet recording device according to claim 1,
wherein the printer forms images on the base material, the images being repeated every predetermined distance in a conveyance direction of the conveyer, and
wherein the controller controls the conveyer to change the conveyance speed between the first conveyance speed and the second conveyance speed after a repeated image having the predetermined distance is formed but before a next repeated image having the predetermined distance is formed.

3. The ink jet recording device according to claim 1,
wherein the cut position information is represented by a line, a mark, a boundary between images, or another visually recognizable form.

4. The ink jet recording device according to claim 1,
wherein the first conveyance speed is higher than the second conveyance speed.

5. The ink jet recording device according to claim 4, further comprising:
a pre-process conveyer that is disposed at a conveyance upstream of the conveyer and conveys the base material in the flatly extended state; and
a base material process unit that performs a process other than printing on the base material conveyed by the pre-process conveyer,
wherein a conveyance speed of the pre-process conveyer is lower than the first conveyance speed and is higher than the second conveyance speed.

6. The ink jet recording device according to claim 5, further comprising: a slack generator that generates a slack of the base material at a conveyance downstream of the pre-process conveyer.

7. The ink jet recording device according to claim 6, further comprising:
a conveyance speed instructor that instructs switching between the first conveyance speed and the second conveyance speed; and
a slack detector that measures the amount of the slack at the slack generator,
wherein the conveyance speed instructor instructs the switching in accordance with a calculation result that is obtained from a measurement result by the slack detector, the conveyance speed at the pre-process conveyer, and the first conveyance speed.

8. The ink jet recording device according to claim 7, wherein the controller controls the printer to stop printing in response to the amount of the slack of the base material measured by the slack detector being equal to or less than a predetermined distance.

9. The ink jet recording device according to claim 5,
wherein the base material process unit performs a corona treatment on the base material.

10. The ink jet recording device according to claim 1, wherein v1×T1=v2×T2 is satisfied, where v1 is the first conveyance speed, T1 is an ejection time interval of the printer at the first conveyance speed v1, v2 is the second conveyance speed, and T2 is an ejection time interval of the printer at the second conveyance speed v2.

11. The ink jet recording device according to claim 1,
wherein the printer includes a head that ejects ink by using a piezoelectric element.
